(19) United States
(12) Patent Application Publication
(10) Pub. No.: US 2006/0125236 A1
(43) Pub. Date: Jun. 15, 2006

(54) Retainer with inward projections

(75) Inventors: Anthony J. Cuvo, Coopersburg, PA (US); Douglas R. Dole, Whitehouse Station, NJ (US)

Correspondence Address: SYNNESTVEDT & LECHNER, LLP, 2600 ARAMARK TOWER, 1101 MARKET STREET, PHILADELPHIA, PA, 191072950, US

(73) Assignee: Victaulic Company of America, Easton, PA (US)

(21) Appl. No.: 11/012,436

(22) Filed: Dec. 15, 2004

(51) Int. Cl. F16L 17/00

(52) U.S. Cl. 285/374

(57) ABSTRACT

A retainer for use in a mechanical pipe coupling is disclosed. The retainer fits within an expanded region of the coupling adjacent to a washer which is adjacent to an incompressible seal. The retainer has a band with opposite edges. Angularly oriented teeth extend inwardly from one edge and engage a pipe inserted into the coupling. Projections located around the opposite edge project inwardly and prevent the washer from telescoping into the band when the seal is under pressure and tries to expand and displace the washer. The projections may be made by forming indentations in the surface of the band.

### FIELD OF THE INVENTION

This invention relates to retainers used with mechanical pipe couplings which effect a strong, reliable joint with a fluid-tight seal without the need for brazing or soldering.

### BACKGROUND OF THE INVENTION

The construction of piping networks requires couplings that can form fluid-tight joints between pipe ends which can withstand external mechanical forces, as well as internal fluid pressure and reliably maintain the integrity of the joint. Many forms of joints are known, such as brazed or soldered joints, threaded joints, welded joints and joints effected by mechanical means.

There are standard pipe fittings such as elbows (45° and 90°), tees and straight segments matched for use with standard tube diameters. The standard fittings have open ends with inner diameters sized to accept the outer diameter of a particular standard tube in mating contact for effecting a joint.

In addition to the standard fittings described above, other components, such as valves, strainers, adapters, flow measurement devices and other components which may be found in a pipe network, will have a coupling which is compatible with the standard pipe, and it is understood that the term “coupling”, when used herein, is not limited to a standard elbow, tee or other fitting but includes the open end of any component useable in a piping network which serves to couple the component to the pipe end.

The soldered joint is used to a great extent for pipe couplings. This joint is effected between a standard diameter tube end and its associated standard fitting by first cleaning the surfaces to be joined, typically with an abrasive such as a wire brush or steel wool, to remove any contaminants and the oxide layer which forms on the surfaces. Next, the cleaned surfaces are coated with a flux material, usually an acid flux, which further disrupts the oxide layer (especially when heated) and permits metal to metal contact between the fitting, the pipe end and the solder. The pipe end is next mated with the fitting thereby bringing the cleaned, flux coated surfaces into contact. The fitting and pipe end are then heated to the melting temperature of the solder, and the solder is applied to the interface between the tube and the fitting. The solder melts, flows between the surfaces of the pipe end and the fitting via capillary action and upon cooling and solidifying forms the solder joint. Excess flux is removed from the outer surfaces to prevent further acid etching of the pipe near the joint.

While the soldered joint provides a strong, fluid-tight connection between pipe end and fitting, it has several disadvantages. Many steps are required to make the soldered joint, thus, it is a time consuming and labor intensive operation. Some skill is required to obtain a quality, fluid-tight joint. Furthermore, the solder often contains lead, and the flux, when heated, can give off noxious fumes, thus, exposing the worker to hazardous substances which can adversely affect health over time. The joint is typically heated with an open gas flame which can pose a fire hazard, as well as a personal burn hazard.

To overcome these disadvantages, many attempts have been made to create mechanical couplings which do not require solder or flame to effect a strong, fluid-tight joint. Such mechanical couplings may comprise a housing having a socket for receiving the pipe end. Adjacent to the socket is an expanded region which accommodates components such as an elastomeric seal for sealing purposes, an annular retainer interposed between the outer diameter of the pipe end and the inner diameter of the coupling to mechanically hold the parts together, a washer positioned between the seal and the retainer and a support collar positioned between the retainer and the opening of the housing. The support collar, in conjunction with the socket, provides a two point support for the pipe end and augments the bending stiffness of the coupling. The washer prevents the seal from being displaced into the retainer under hydraulic pressure. Without the washer, the seal may ride up on the retainer teeth, unseat itself from the pipe end , and form a leak path within the coupling.

The retainer may have a band from which teeth extend radially inwardly to dig into the surface of the pipe end to resist extraction of the pipe end from the coupling after engagement. In such a coupling, the washer and the band have diameters that are close in size, and it is found that the washer may be forced within the band by pressure placed upon the washer by the seal as it deforms when a pipe end is engaged within the coupling or by the hydraulic pressure of the fluid within the pipe. If the washer “telescopes” into the retainer band then the seal is not properly confined within the housing and may lose its preload against the pipe and the housing, resulting in a leaky joint.

It is clearly advantageous to develop a retainer for a coupling wherein the telescoping of the washer into the retainer is prevented so as to maintain the fluid tight integrity of the joint.

### SUMMARY OF THE INVENTION

The invention concerns a retainer positionable within a pipe coupling for retaining a pipe end within the coupling. The retainer comprises a circumferential band surrounding a central axis and having an outwardly facing surface engageable with an inwardly facing surface of the pipe coupling. The band has first and second edges oppositely disposed. A plurality of teeth are attached to the first edge of the band and project inwardly. The teeth are angularly oriented toward the second edge of the band and are engageable with the pipe positioned coaxially within the band. A plurality of projections are positioned along the second edge of the band. The projections are arranged in spaced apart relation and project inwardly toward the central axis.

Preferably, each projection is formed from an indentation in the outwardly facing surface of the band. The projections are preferably spaced around the band at equal angular intervals.

In alternate embodiments, the retainer may comprise a band having first and second oppositely disposed ends wherein teeth extend from the first end and a substantially continuous projection extends circumferentially around the second end of the band and projects inwardly toward the central axis; or, the retainer may comprise a band having first and second opposite ends wherein the teeth extend from the first end and the second end has a smaller diameter than the first end.

The invention also includes a coupling assembly for receiving an end of a pipe. The coupling assembly comprises a housing having a socket for receiving one of the pipe ends and an expanded region positioned adjacent to the socket. A seal is positioned within the expanded region adjacent to the socket. The seal is sealingly engageable with the housing and the pipe. A washer is positioned within the expanded region adjacent to the seal. The washer has an outer perimeter engaged with the housing. An annular retainer is positioned within the expanded region adjacent to the washer. The retainer comprises a circumferential band surrounding a central axis and having an outwardly facing surface engaged with the housing within the expanded region. The band has first and second edges oppositely disposed. A plurality of teeth project angularly inwardly from the first edge toward a peripheral surface portion of the pipe. The teeth are engageable with the peripheral surface portion of the pipe positioned coaxially within the housing. A plurality of projections are positioned along the second edge of the band. The projections are arranged in space apart relation and project inwardly toward the central axis. The washer engages the seal, the projections engage the washer and prevent any portion of the washer from moving into the band when the seal is subject to pressure within the housing. The projections also prevent the retainer from being forced over the washer when the pipe end is inserted into the coupling. The pipe end interacts with the retainer teeth and tends to force the retainer against the washer as it is inserted into the coupling.

In alternate embodiments of the coupling assembly, the retainer may have a substantially continuous circumferential projection or an end having a smaller diameter as described above.

### BRIEF DESCRIPTION OF THE DRAWINGS

FIG. 1 is a perspective view of a retainer according to the invention;

FIG. 2 is a longitudinal sectional view of a pipe coupling assembly using a retainer according to the invention;

FIG. 3 is an exploded perspective view of a pipe coupling assembly in the form of an elbow fitting using a retainer according to the invention;

FIG. 4 is a partial plan view taken along lines 4-4 of FIG. 1;

FIG. 5 is a perspective view of another embodiment of a retainer according to the invention;

FIG. 6 is a cross sectional view taken at line 6-6 of FIG. 5;

FIG. 7 is a perspective view of another embodiment of a retainer according to the invention;

FIG. 8 is a cross-sectional view taken at line 8-8 of FIG. 7;

FIG. 9 is a cross-sectional view of another embodiment of a retainer; and

FIGS. 10-12 are longitudinal sectional views of coupling assemblies using retainers according to the invention.

### DETAILED DESCRIPTION OF THE PREFERRED EMBODIMENT

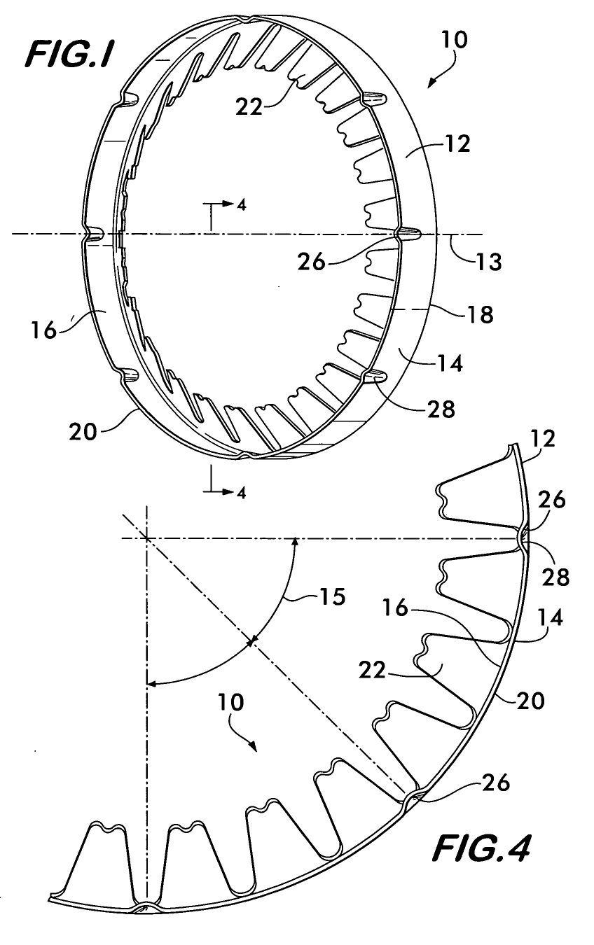

FIG. 1 shows a retainer 10 according to the invention. Retainer 10 comprises a band 12 that extends circumferentially and surrounds a central axis 13. Band 12 is preferably thin walled and has an outwardly facing surface 14 and an inwardly facing surface 16. Band 12 has a leading edge 18 and a free edge 20 oppositely disposed from the leading edge. A plurality of teeth 22 are attached to the leading edge 18 and project inwardly toward the central axis 13. The teeth 22 are angularly oriented and slope toward the free edge 20 for reasons explained below.

As best shown in FIGS. 1 and 4, a plurality of projections 26 are positioned in spaced relation along the free edge 20 of band 12. The projections 26 project from the inwardly facing surface 16 inwardly toward the central axis 13 and are preferably spaced in substantially equal angular intervals 15 around the band. A preferred embodiment of the retainer 10 has 8 projections 26 spaced at 45 degree intervals. Other embodiments may have, for example, 4 projections spaced at 90 degree intervals.

Preferably, the projections 26 are formed by an indentation 28 in the outwardly facing surface 14 of the band 12. Indentations 28 preferably extend in a direction from the free edge 20 toward the leading edge 18, but only traverse between about ⅓ to ⅔ of the width of the band. Preferably, the depth of the indentation is about three times the thickness 30 of the band.

The retainer is preferably made from durable, corrosion-resistant metals such as stainless steel, and thus, the indentations 28 may be readily formed by application of a punch to the band. The band thickness will vary according to the size of the retainer with large diameter bands having greater thickness than smaller diameter bands. A maximum band thickness of about 0.020 inches is preferred to facilitate the incorporation of indentations 28.

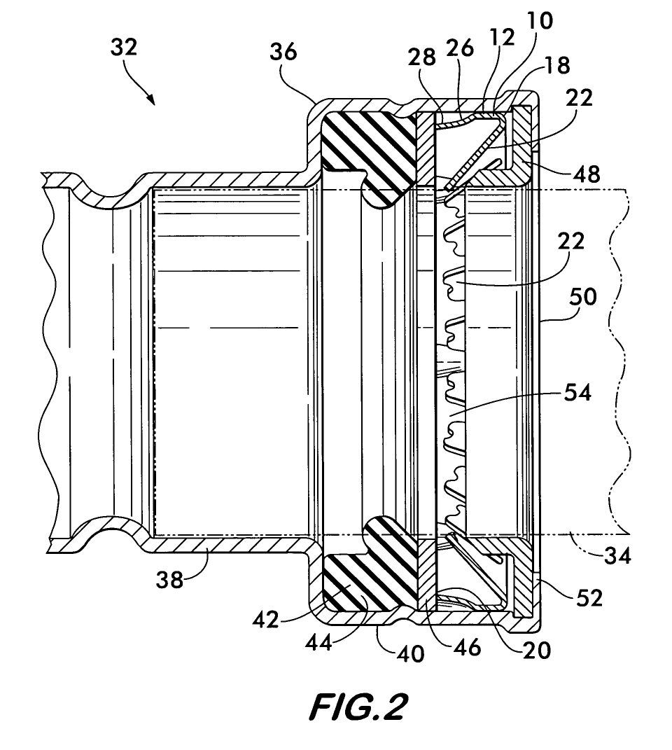

As shown in FIG. 2, retainer 10 is one of several internal components used with a coupling 32 for receiving a pipe end 34, shown in phantom line. Coupling 32 provides a fluid tight joint with the pipe end 34 and includes a housing 36 with a socket 38 adapted to receive and support the pipe end 34. Housing 36 has an expanded region 40 adjacent to the socket where the internal components reside. Positioned within the expanded region 40 adjacent to the socket 38 is a seal 42. Preferably, seal 42 is an elastomeric loop 44 which is compressed between the pipe end 34 and the housing 36 to effect a fluid-tight seal. A washer 46 is positioned within the expanded region 40 adjacent to the seal, and the retainer 10 is positioned adjacent to the washer 46 with its free edge 20 facing the washer. A support collar 48 may be positioned adjacent to the retainer 10 at the opening 50 of the housing 36 which receives the pipe end 34. The various components are held within the expanded region, for example, by a retaining lip 52 extending circumferentially around the housing and projecting radially inwardly.

When seal 42, which is substantially incompressible, is subjected to pressure, for example, outward radial pressure from contact with pipe end 34 and hydraulic pressure from fluid within the pipe and coupling, it will tend to expand longitudinally and force the washer 46 into contact with the free edge 20 of retainer 10. The pressure exerted on the washer 46 by the seal 42 may be great enough to force the washer coaxially into the band 12. This condition is undesirable as it will tend to relieve the pressure between the pipe end 34 and the seal 42 as well as between the housing 36 and the seal. If the pressure on seal 42 is relaxed then it will tend to leak at a lower pressure. The inwardly oriented projections 26 positioned along free edge 20 engage the washer 46 and prevent the washer from “telescoping” coaxially into the band 12 and thereby maintain the pressure on the seal to ensure a fluid tight joint between the coupling housing 36 and the pipe 34. The projections 26 also prevent a portion of the washer 46 from being forced into the retainer. In the absence of projections, this may happen when the washer and the retainer are positioned eccentrically to one another within the coupling housing, as can occur due to varying manufacturing tolerances between the parts. With the eccentric positioning, a portion of the washer perimeter will not be supported by the free edge 20 of band 12, and thus, when the washer is subjected to pressure from the seal 42, the washer 46 may tend to rotate or bend and its unsupported portion may be forced into the retainer. With projections 26, however, there is always adequate support of the washer perimeter to prevent its entry into the retainer 10 regardless of the relative eccentricity between the washer and the retainer due to manufacturing tolerances.

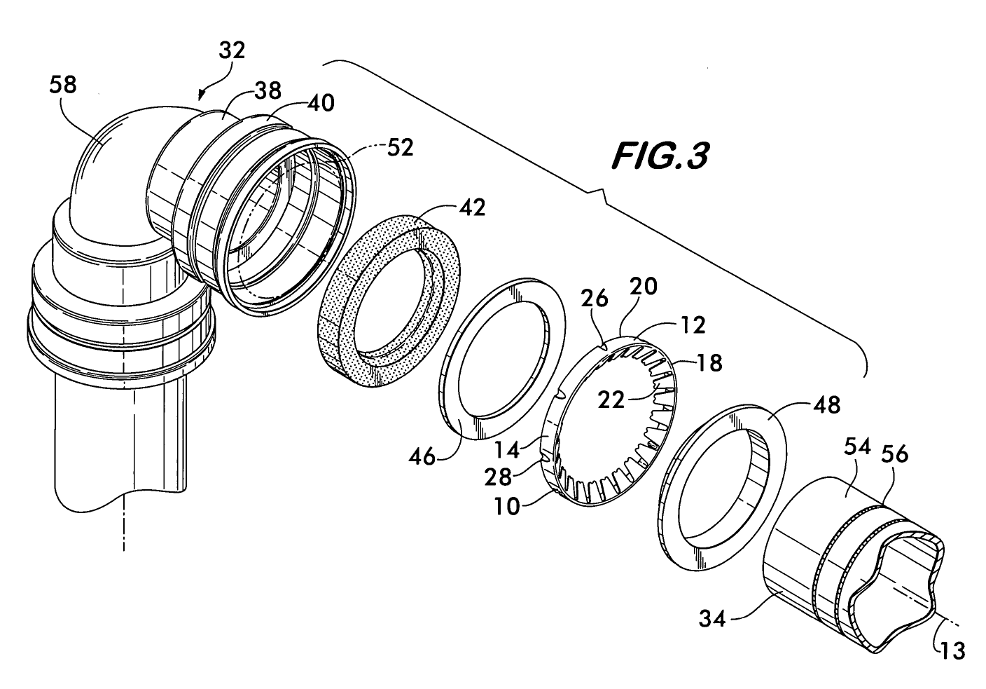

Teeth 22, arranged around the leading edge 18 of band 12, project inwardly and engage the peripheral surface portion 54 of the pipe end 34. Because they are angularly oriented to slope toward the free edge 20 and are biased into engagement with pipe 34, the teeth allow the pipe to be inserted through opening 50 and into socket 38, but prevent extraction of the pipe end from the housing. The retaining action of teeth 22 may be augmented by the use of circumferential grooves 56 in the pipe end 34 as shown in FIG. 3. The teeth engage the grooves 56 when present, the grooves providing additional purchase for the teeth 22 in the peripheral portion 54 of the pipe end 34.

FIG. 3 provides an exploded view of an embodiment of a coupling 32 according to the invention. In this view the coupling has an elbow shaped housing 58 which has a socket 38 and an adjacent expanded region 40. The seal 42, washer 46, retainer 10 and support collar 48 are positioned within the expanded region and held in place, for example, by the retaining lip 52, shown in phantom line. The retainer 10 may be used in any type of coupling, for example, a straight coupling, a tee, and elbow (shown) as well as couplings that incorporate fittings such as valves, strainers, reducers, expanders and orifices.

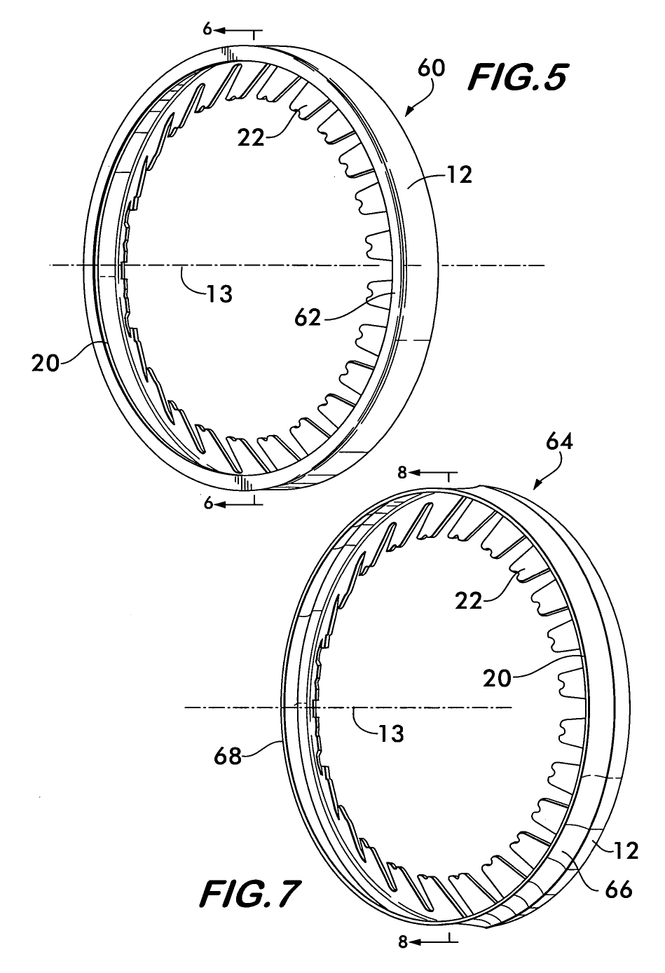

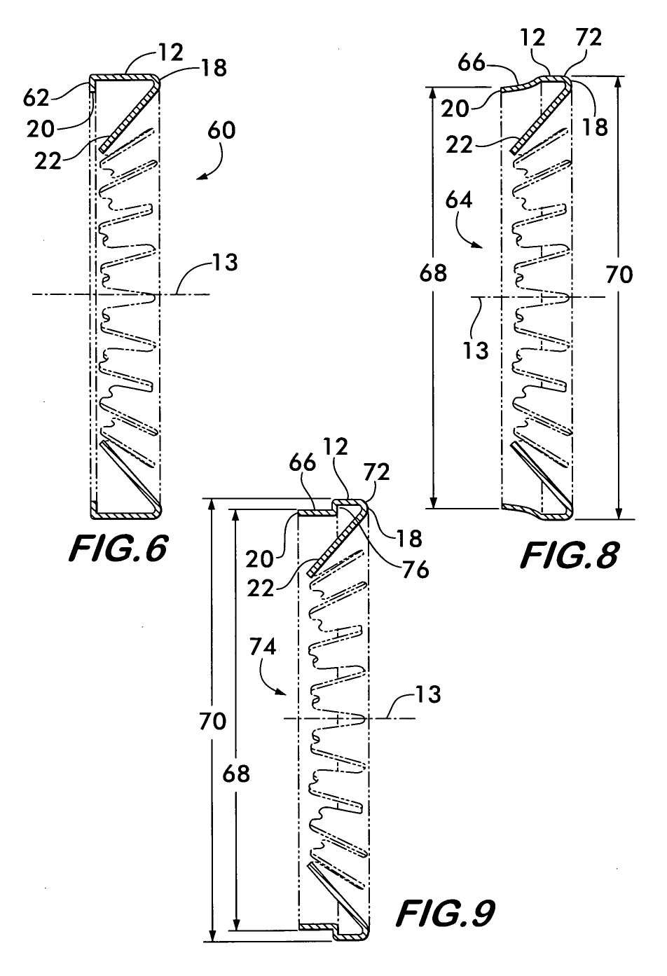

FIGS. 5 through 9 illustrate other embodiments of the retainer according to the invention. In FIGS. 5 and 6, the retainer 60 has a substantially circumferentially continuous projection 62 that extends inwardly from an end of band 12. Preferably, projection 62 is formed by inwardly bending a portion of the band 12 adjacent to the free edge 20 so that the free edge faces toward axis 13 as best shown in the cross-section of FIG. 6.

In yet another embodiment shown in FIGS. 7 and 8, a retainer 64 has a band 12 with an end 66 that includes free edge 20 and has a smaller diameter 68 than the diameter 70 of the opposite end 72 that includes the leading edge 18. The smaller diameter ensures that free edge 20 will always engage the washer 46 and prevent its ingress into the retainer. In this embodiment, end 66 is preferably tapered inwardly relative to opposite end 72.

In another embodiment of a retainer 74, shown in FIG. 9, end 66 of band 12 is offset inwardly relative to end 72. End 66 is connected to the band by a shoulder 76 that is oriented angularly to both the band and the end. Preferably, the orientation angles are about 90 degrees, although other angular relations are feasible. This configuration provides a retainer wherein the end 66 has a smaller diameter 68 than the diameter 70 of opposite end 72 , thereby again ensuring engagement between the free edge 20 and the washer within the coupling.

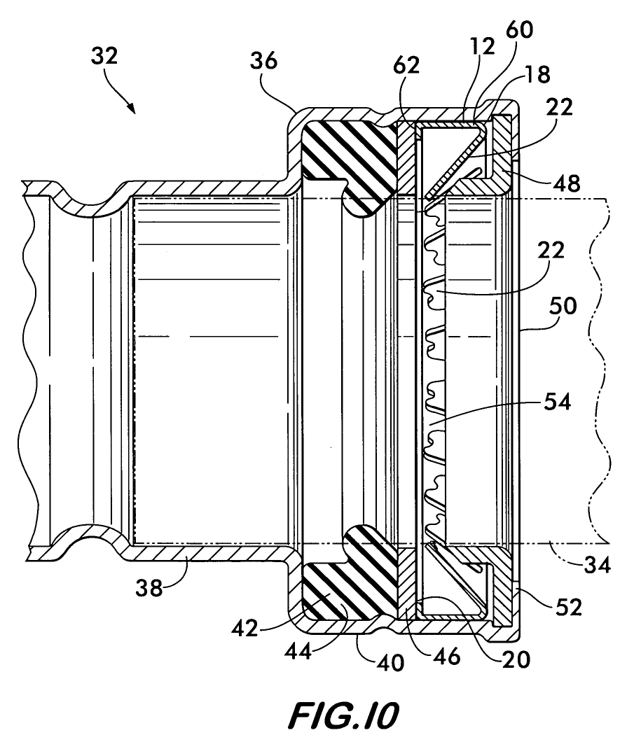

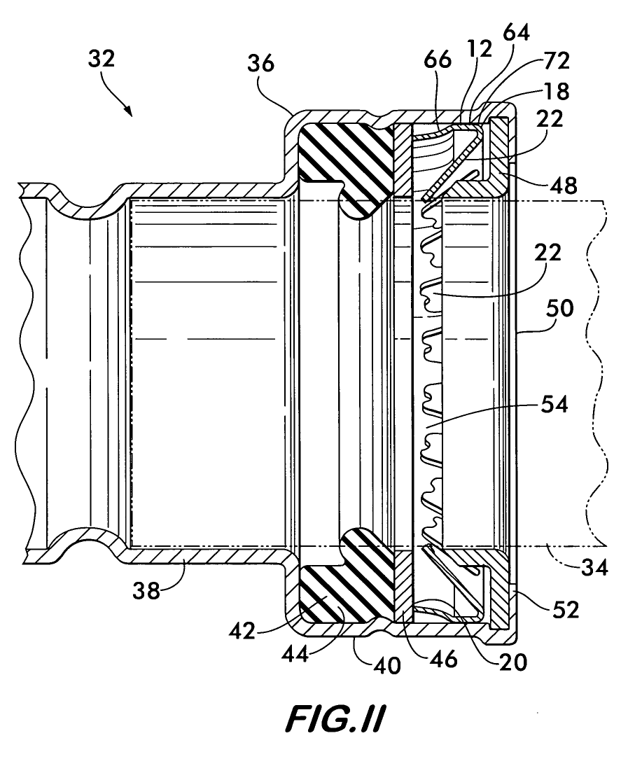

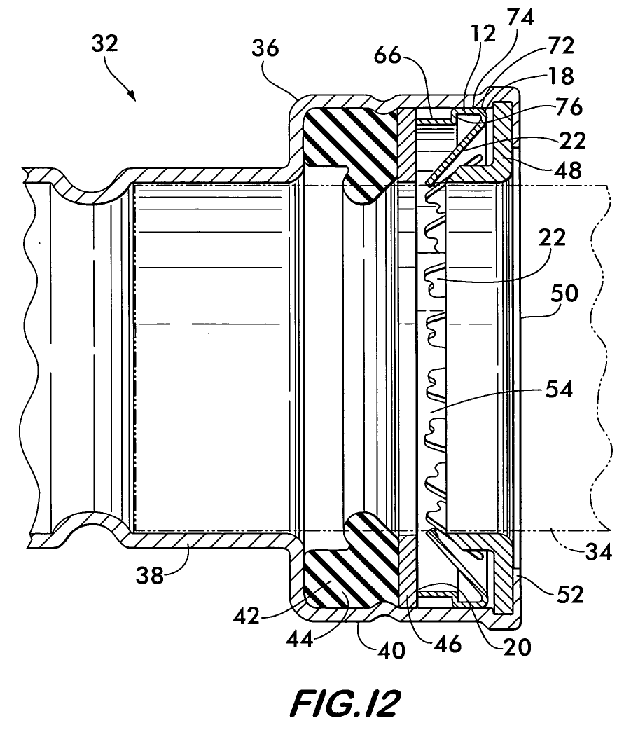

FIGS. 10-12 show, respectively, the retainer embodiments 60, 64 and 74 as part of coupling assembly 32. The overall description of the coupling assemblies is similar to that as described above and will not be repeated here. However, we note in FIG. 10 how the projection 62 engages washer 46 to keep it out of the retainer band 12. Similarly, in FIGS. 11 and 12, free edge 20 engages washer 46 as a result of the smaller diameter of the end 66 as compared with end 72, thereby ensuring that no portion of the washer 46 enters within the band 12.

Couplings according to the invention provide a mechanical pipe coupling which can form a reliable fluid-tight joint without the hazards associated with brazing, welding or soldering. Use of the retainer ensures a reliable joint with a fluid tight seal that will not allow the seal to relax and thereby withstand relatively higher pressures.

What is claimed is:

1. A retainer positionable within a pipe coupling for retaining a pipe end within said coupling, said retainer comprising:
a circumferential band surrounding a central axis and having an outwardly facing surface engageable with an inwardly facing surface of said pipe coupling, said band having first and second edges oppositely disposed;
a plurality of teeth attached to said first edge of said band and projecting inwardly, said teeth being angularly oriented toward said second edge of said band and being engageable with said pipe when positioned within said band; and
a plurality of projections being positioned along said second edge of said band, said projections being arranged in spaced apart relation and projecting inwardly toward said central axis.

2. A retainer according to claim 1, wherein each of said projections comprises an indentation in said outwardly facing surface of said band.

3. A retainer according to claim 1, wherein said projections are spaced around said band at equal angular intervals.

4. A retainer according to claim 2, wherein said band has a predetermined thickness, and said indentations have a depth of approximately three times said band thickness.

5. A retainer according to claim 1, wherein said band has between 4 and 8 projections.

6. A retainer according to claim 2, wherein said band has 8 indentations space apart at 45° intervals around said band.

7. A retainer according to claim 2, wherein said indentations extend from said second edge toward said first edge.

8. A retainer positionable within a pipe coupling for retaining a pipe end within said coupling, said retainer comprising:
a circumferential band surrounding a central axis and having an outwardly facing surface engageable with an inwardly facing surface of said pipe coupling, said band having first and second edges oppositely disposed;
a plurality of teeth attached to said first edge and projecting inwardly, said teeth being angularly oriented toward said second edge and being engageable with an outwardly facing surface of said pipe positioned coaxially within said band; and
a plurality of indentations positioned in said surface of said band along said second edge thereof, said indentations being arranged in spaced apart relation around said band and deforming said second edge so as to project inwardly toward said central axis.

9. A retainer according to claim 8, wherein said indentations are spaced around said band at equal angular intervals.

10. A retainer according to claim 8, wherein said band has a predetermined thickness, and said indentations have a depth of approximately three times said band thickness.

11. A retainer according to claim 8, wherein said band has between 4 and 8 indentations.

12. A retainer according to claim 8, wherein said band has 8 indentations spaced apart at 45° intervals around said band.

13. A retainer according to claim 8, wherein said indentations extend from said second edge toward said first edge.

14. A coupling assembly for receiving an end of a pipe, said coupling assembly comprising:
a housing having a socket for receiving said pipe end and an expanded region positioned adjacent to said socket;
a seal positioned within said expanded region adjacent to said socket, said seal being sealingly engageable with said housing and said pipe;
a washer positioned within said expanded region adjacent to said seal;
an annular retainer positioned within said expanded region adjacent to said washer, said retainer comprising a circumferential band surrounding a central axis and having an outwardly facing surface, said band having first and second edges oppositely disposed;
a plurality of teeth projecting angularly inwardly from said first edge toward a peripheral surface portion of said pipe, said teeth being engageable with said peripheral surface portion for retaining said pipe within said housing; and
a plurality of projections positioned along said second edge of said band, said projections being arranged in spaced apart relation and projecting inwardly toward said central axis, said washer engaging said seal, said projections engaging said washer and preventing any portion thereof from moving within said band when said seal is subject to pressure within said housing.

15. A coupling assembly according to claim 14, wherein each of said projections comprises an indentation in said outwardly facing surface of said band.

16. A coupling assembly according to claim 14, wherein said projections are spaced around said band at equal angular intervals.

17. A coupling assembly according to claim 15, wherein said band has a predetermined thickness, and said indentations have a depth of approximately three times said band thickness.

18. A coupling assembly according to claim 14, wherein said band has between 4 and 8 projections.

19. A coupling assembly according to claim 15, wherein said band has 8 indentations spaced apart at 45° intervals around said band.

20. A coupling assembly according to claim 15, wherein said indentations extend from said second edge toward said first edge.

21. A retainer positionable within a pipe coupling for retaining a pipe end within said coupling, said retainer comprising:
a circumferential band surrounding a central axis, said band having first and second ends oppositely disposed;
a plurality of teeth attached to said first end of said band and projecting inwardly, said teeth being angularly oriented toward said second end of said band and being engageable with said pipe when positioned within said band; and
a substantially continuous projection extending circumferentially around said second end and projecting inwardly toward said central axis.

22. A retainer according to claim 21, wherein said projection is formed by bending a portion of said band at said second end at an angle relatively to said band.

23. A retainer according to claim 22, wherein said projection is oriented at an angle of about 90° to said band.

24. A retainer positionable within a pipe coupling for retaining a pipe end within said coupling, said retainer comprising:
a circumferential band surrounding a central axis, said band having first and second ends oppositely disposed, said second end having a diameter less than the diameter of said first end; and
a plurality of teeth attached to said first end of said band and projecting inwardly, said teeth being angularly oriented toward said second end of said band and being engageable with said pipe when positioned within said band.

25. A retainer according to claim 24, wherein said second end is tapered inwardly relatively to said first end.

26. A retainer according to claim 24, wherein said second end is inwardly offset from said first end, a shoulder extending between said band and said second end, said shoulder being angularly oriented with respect to said band and said second end.

27. A retainer according to claim 26, wherein said shoulder is oriented at about 90° relative to said band and said second end.

28. A coupling assembly for receiving an end of a pipe, said coupling assembly comprising:
a housing having a socket for receiving said pipe end and an expanded region positioned adjacent to said socket;
a seal positioned within said expanded region adjacent to said socket, said seal being sealingly engageable with said housing and said pipe;
a washer positioned within said expanded region adjacent to said seal;
an annular retainer positioned within said expanded region adjacent to said washer, said retainer comprising a circumferential band surrounding a central axis, said band having first and second ends oppositely disposed;
a plurality of teeth projecting angularly inwardly from said first end toward a peripheral surface portion of said pipe, said teeth being engageable with said peripheral surface portion for retaining said pipe within said housing; and
a substantially continuous projection extending circumferentially around said second end and projecting inwardly toward said central axis, said projection engaging said washer and preventing any portion thereof from moving within said band when said seal is subject to pressure within said housing.

29. A coupling assembly for receiving an end of a pipe, said coupling assembly comprising:
a housing having a socket for receiving said pipe end and an expanded region positioned adjacent to said socket;
a seal positioned within said expanded region adjacent to said socket, said seal being sealingly engageable with said housing and said pipe;
a washer positioned within said expanded region adjacent to said seal;
an annular retainer positioned within said expanded region adjacent to said washer, said retainer comprising a circumferential band surrounding a central axis, said band having first and second ends oppositely disposed, said second end having a diameter less than the diameter of said first end; and
a plurality of teeth attached to said first end of said band and projecting angularly inwardly toward a peripheral surface portion of said pipe, said teeth being engageable with said peripheral surface portion for retaining said pipe within said housing, said second end engaging said washer and preventing any portion thereof from moving within said band when said seal is subject to pressure within said housing.
